(19) United States
(12) Patent Application Publication
(10) Pub. No.: US 2013/0117645 A1
(43) Pub. Date: May 9, 2013

(54) Method and Apparatus for Generating a Feed of Updating Content

(71) Applicants: Stefan Butlin, Cambridge (GB); Simon Rodgers, Ely (GB); Christopher Porter, Suffolk (GB)

(72) Inventors: Stefan Butlin, Cambridge (GB); Simon Rodgers, Ely (GB); Christopher Porter, Suffolk (GB)

(73) Assignee: TAPTU LTD, Cambridge (GB)

(21) Appl. No.: 13/288,123

(22) Filed: Nov. 3, 2011

(51) Int. Cl. G06F 17/00

(52) U.S. Cl. 715/205; 715/234

(57) ABSTRACT

The application describes a first system for monitoring changes to a target web page and also a second system for providing information on changes to a target web page. The first system is configured to display said target web page to a user; receive a user specification of at least one sub-region within said displayed target web page; download, at a subsequent time, said target web page; determine whether or not there have been any changes to said at least one sub-region, and if there are any changes, output an update comprising data from said at least one sub-region. The second system is configured to download a target web page associated with said user specification; and if there is a new link, download a new web page associated with said new link; generate an article derived from said new web page; and output said article as an update.

### FIELD OF THE INVENTION

This invention relates to servers for generating a feed of updating content, to corresponding methods of generating such feeds, and corresponding apparatus and software.

### BACKGROUND ART

There are many websites on the world wide web that publish feeds of updating content via RSS (or similar). These feeds let internet users, or third party services, automatically monitor them as a simple method of detecting when new content is available. However, there are many other websites that do not publish convenient RSS feeds, yet still contain updating information that internet users, or third party services, would wish to keep up to date with.

There are a number of existing services that attempt to alleviate this problem. For example, there are web services that allow users to configure one or more URLs that will be periodically checked for new or changed content. When a change has been detected, the user is notified of the change, typically, either by email or via an RSS feed populated with the new contents as they are detected. Examples of this kind of service include http://pape2rss.com and http://www.infominder.com. There are other services available that take this a step further and allow the users to specify filters or specific fields within a web page to limit how much of the page is monitored for change. An example of this kind of page filtering can be found at http://femtoo.com.

All of these services only go as far as monitoring the page itself for change, and notifying the users of the changes to the page, sometimes additionally conveying information about what that change was. The present applicants have recognised the need for an improved method and system for creating feeds of updating content.

### SUMMARY OF THE INVENTION

The present invention provides a system and method for the easy creation of feeds of updating content. In the first aspect the user is able to control which sub-regions of a target web page are monitored for change. In the second aspect, the articles provide content in the feed which is rich and relevant. Both aspects may be combined to provide a rich and relevant feed about user selected elements.

The updates may be sent to a user device, direct or via a publishing server. The user device may be a mobile device which may be any kind of mobile computing device, including laptop and hand held computers, portable music players, portable multimedia players, mobile phones. On such device, the display screen may have limited space. The present invention addresses this problem in two ways, first by restricting the update to a sub-region of the target web page and secondly by outputting an article based on an updated link within the sub-region. Such an article contains a summary of the updated link not simply the full webpage of the link. Both the specification of the sub-region and the template for the summary can be user-defined which permits a better user experience.

According to a first aspect of the invention, there is provided a system and method for monitoring changes to a target web page.

The system is configured to display said target web page to a user; receive a user specification of at least one sub-region within said displayed target web page; download, at a subsequent time, said target web page associated with said user specification; identify said at least one sub-region of said user specification within said target web page; determine whether or not there have been any changes to said at least one sub-region, and if there are any changes, output an update comprising data from said at least one sub-region.

The system may comprise a region selection tool which is configured to carry out the displaying and receiving steps. The system may comprise a target page crawler which is configured to carry out the identifying, determining and outputting steps. The region selection tool may receive the user specification from a user and may output the user specification to the target page crawler. Alternatively, the region selection tool may output the user specification to a specification database and the target page crawler may access the user specification from the specification database.

The system may further comprise an article crawler which is configured to download a new web page associated with said new link; generate an article derived from said new web page; and output said article as said update. The region selection tool may be configured to display said new web page to a user; and receive a user defined template of an article to be based on said new web page from said user. The region selection tool may output the user defined template to the article crawler for the generation of the article.

According to a second aspect of the invention, there is provided a system and method for providing articles containing updates about links within a sub-region of a target web page.

The system is configured to access a user sub-region specification specifying a target web page and at least one of said sub-regions within said target web page; download said target web page associated with said user specification; identify said at least one sub-region of said user specification within said target web page; determine whether or not there is a new link within said at least one sub-region, and if there is a new link, download a new web page associated with said new link; generate an article derived from said new web page; and output said article as an update.

The system may comprise a target page crawler configured to carry out the accessing, downloading, identifying and determining steps and an article crawler which is configured to carry out the downloading of the new web page, generating and outputting steps. The target page crawler may output the new link to the article crawler.

According to the combined aspect of the invention, there is provided a system which is configured to display said target web page to a user; receive a user specification of at least one sub-region within said displayed target web page; download, at a subsequent time, said target web page associated with said user specification; identify said at least one sub-region of said user specification within said target web page; determine whether or not there is a new link within said at least one sub-region, and if there is a new link, download a new web page associated with said new link; generate an article derived from said new web page; and output said article as an update.

The system may comprise region selection tool which is configured to carry out the displaying and receiving steps, a target page crawler configured to carry out the downloading, identifying and determining steps and an article crawler which is configured to carry out the downloading of the new web page, generating and outputting steps.

In each embodiment of the invention, the region selection tool, target page crawler and article crawler may be implemented as modules on a single server or a plurality of interconnected servers. One or more of the modules may be provided on a user device.

The invention further provides processor control code to implement the above-described systems and methods, for example on a general purpose computer system or on a digital signal processor (DSP). The code is provided on a physical data carrier such as a disk, CD- or DVD-ROM, programmed memory such as non-volatile memory (eg Flash) or read-only memory (Firmware). Code (and/or data) to implement embodiments of the invention may comprise source, object or executable code in a conventional programming language (interpreted or compiled) such as C, or assembly code. As the skilled person will appreciate such code and/or data may be distributed between a plurality of coupled components in communication with one another.

### BRIEF DESCRIPTION OF THE DRAWINGS

The invention is diagrammatically illustrated, by way of example, in the accompanying drawings, in which:

FIG. 1 is a schematic block diagram of a screenshot of an example target website;

FIG. 2 is the graphical user interface of the present invention incorporating the screenshot of FIG. 1 with a sub-region of said screenshot selected;

FIG. 3a is a schematic block diagram of the components of one arrangement of the system;

FIG. 3b is a schematic block diagram of the components of one arrangement of the system;

FIG. 4 is a flowchart of the steps of the method carried out by the region selection tool of FIG. 3;

FIG. 5 is a flowchart of the steps of the method carried out by the target page crawler of FIG. 3;

FIG. 6 is a flowchart of the steps of the method carried out by the article crawler of FIGS. 3, and

FIG. 7 is a flowchart of the steps of the optional method carried out by the region selection tool.

### DETAILED DESCRIPTION OF THE DRAWINGS

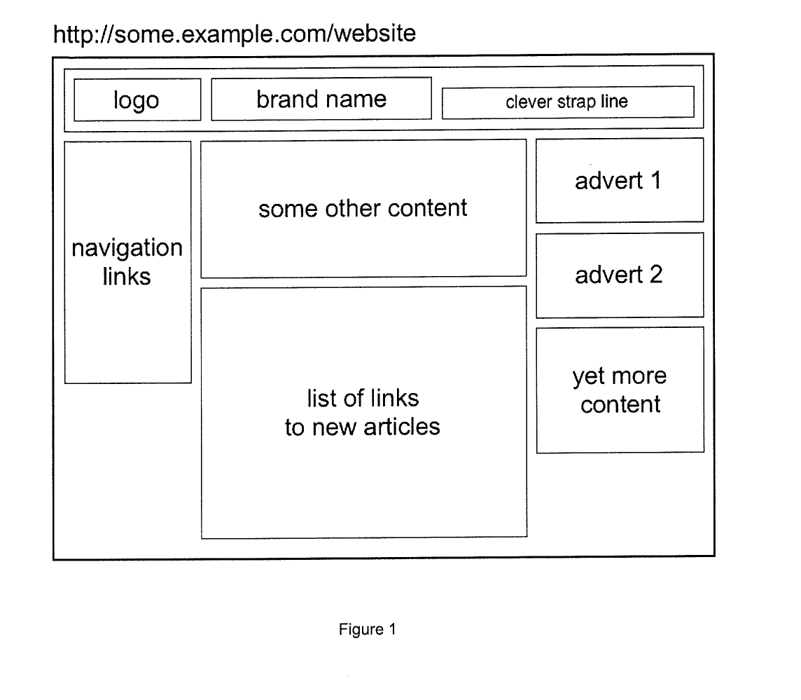

FIG. 1 shows a screenshot of a page from an example website. There are a plurality of sub-regions within the displayed website page, e.g. a sub-region having a list of links to new articles, sub-regions with adverts, a sub-region with a logo displayed, a sub-region with a brand name displayed, other sub-regions with other types of content. Such a website page may be termed a “headline” pages. These are pages that display a list of headlines, each headline (and sometimes short summary paragraph) linking to the full article. News websites are an obvious example of this pattern. Shopping sites, with front pages (or department-specific front-pages) containing updating lists of featured products, each product typically linking to a full page about the article, are also an example of this pattern. In these cases, a user interested in a feed of new content from these websites is much better satisfied with a feed that contains the linked information.

Furthermore, as shown in FIG. 1, web pages, particularly those designed for consumption on a laptop or desktop computer, are typically fairly heavy with “other” content, e.g. navigation structures, related links, user comments, adverts. All of these are superfluous to the user who is trying to simply consume the new content itself. This problem is particularly relevant when the content is being consumed on devices with smaller screens, e.g. smartphones and tablets.

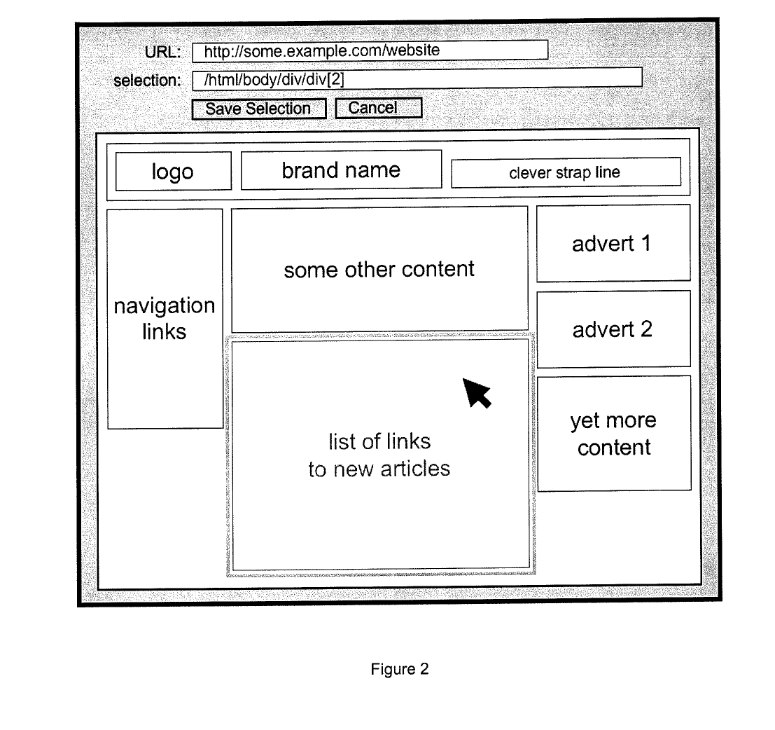

FIG. 2 shows a graphical user interface displaying the screenshot of FIG. 1 and enabling a user to select sub-regions to create a sub-region specification as described in more detail below. In this embodiment, the graphical user interface is driven by a mouse interface. Thus as shown in FIG. 2, a user can drag a mouse pointer over the screen and can highlight sub-regions, e.g. the sub-region having a list of links to new articles, i.e. a list of “headlines”. At the top of the screen, above the displayed screenshot, the graphical user interface also displays the URL of the target website together with a textual representation of the sub-region selected. The user can confirm or cancel a selection by clicking on a button on the interface, e.g. “save selection” or “cancel”.

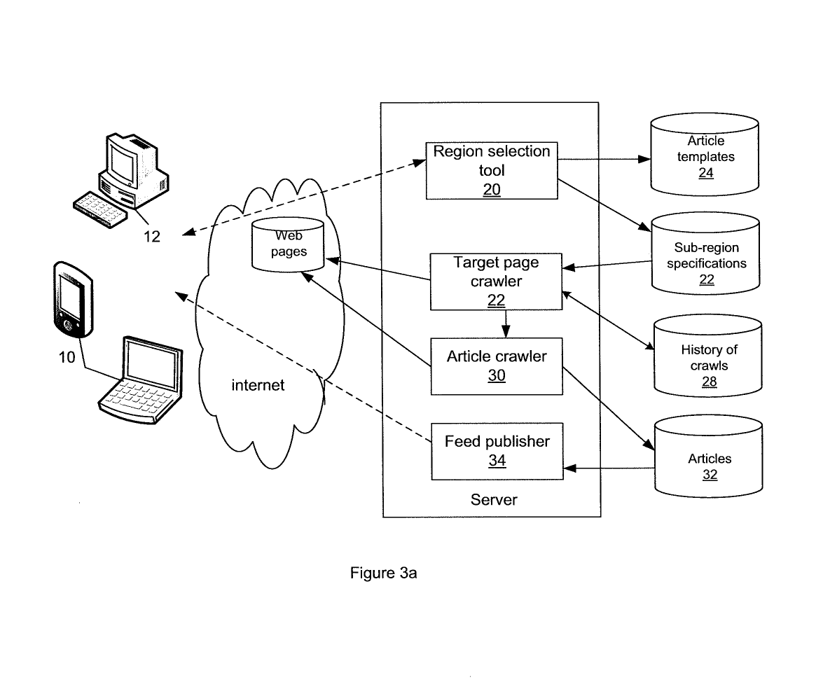

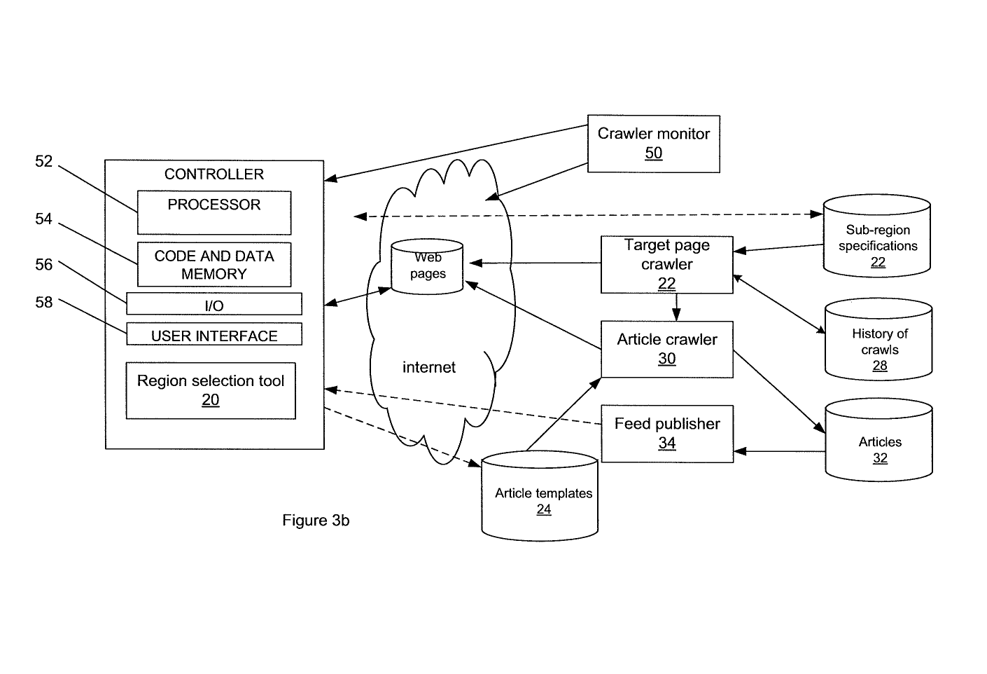

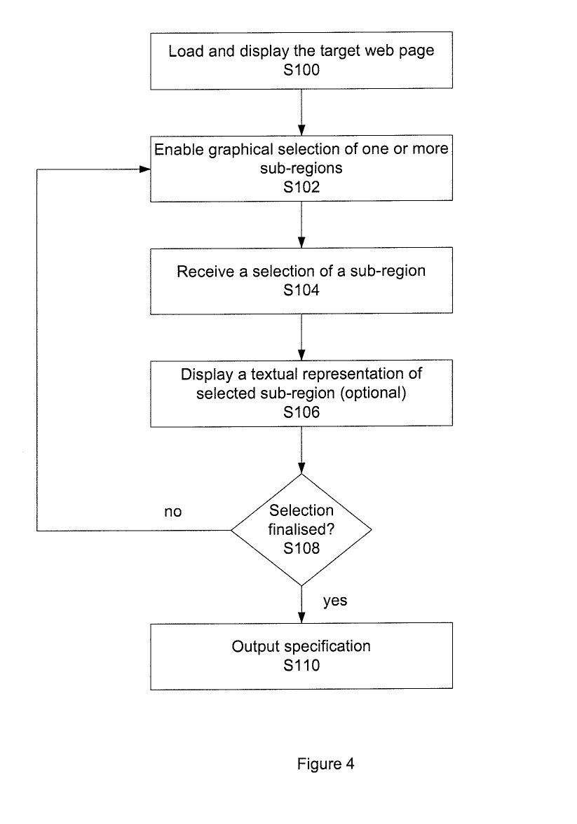

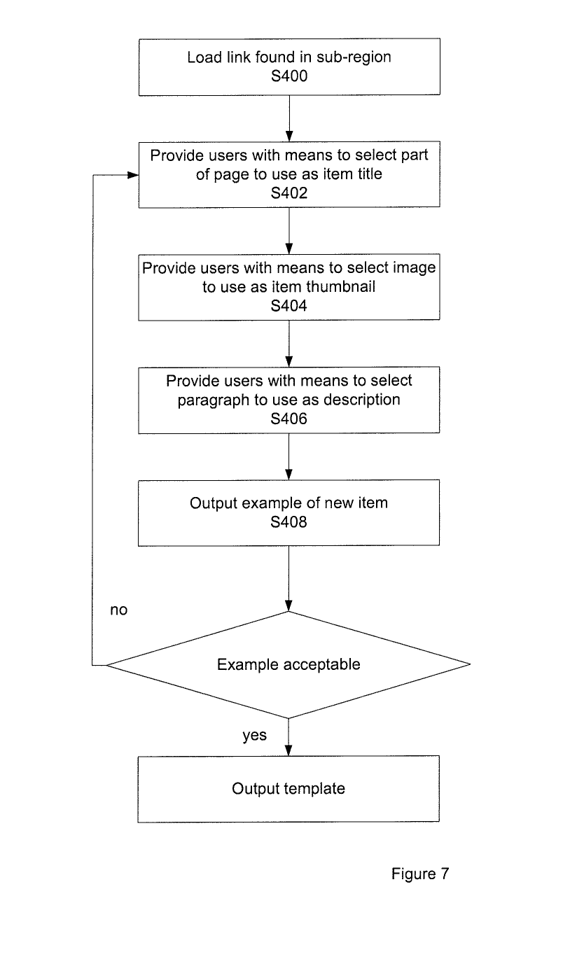

The overall topology of the components of the system of the invention is illustrated in FIGS. 3a and 3b. In both arrangements, the system comprises a region selection tool 20 which is used to identify regions of a web page to monitor for new articles. The region selection tool 20 is connected to a database 22 which stores a list of sub-region specifications created as described with reference to FIG. 4. The region selection tool is also connected to an optional database 24 which stores templates which may be used for creating the articles as described with reference to FIG. 7.

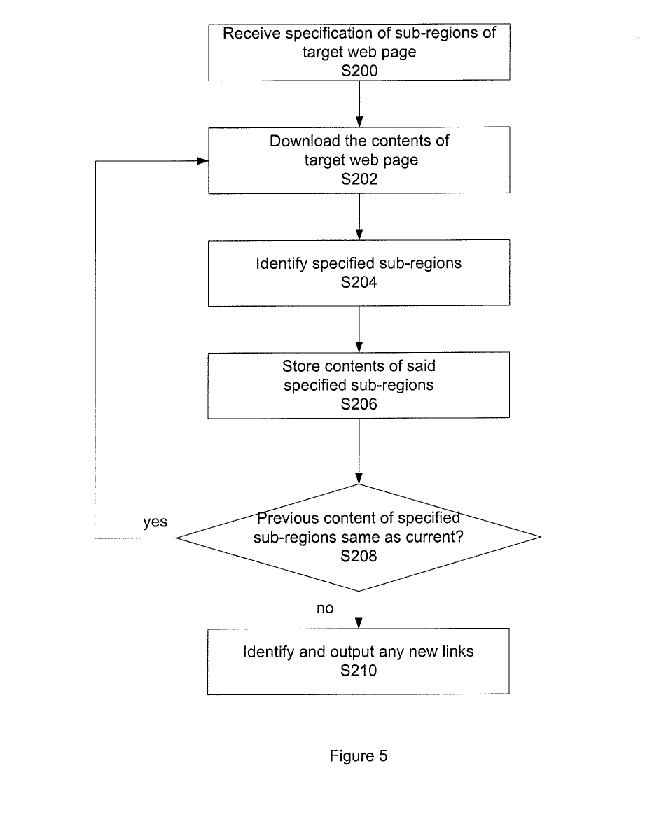

The system also comprises a target page crawler 26 which shown as connected to the sub-region specification database 22. The target page crawler 26 may thus access sub-region specifications from the database, e.g. in an automated manner. Alternatively, the target page crawler 26 may be connected to the region selection tool 20 to receive the sub-region specification direct. As described in more detail with reference to FIG. 5, the target page crawler comprises a crawler service that allows it to load the target webpage, extract the sub-regions, and compare the set of links in the sub-region to those that were present the previous time the webpage was opened. The target page crawler is connected to a history database 28 to store the history of previous crawls.

The target page crawler may be termed a page-region monitor tool. This is a service that periodically monitors one or more web pages and sub-region specifications. The service could be deployed as software running on servers in support of many users, each with several different web pages to monitor. Alternatively, the service could be run on the personal computer of the user, either when activated by the user, or automatically in the background on a periodic basis.

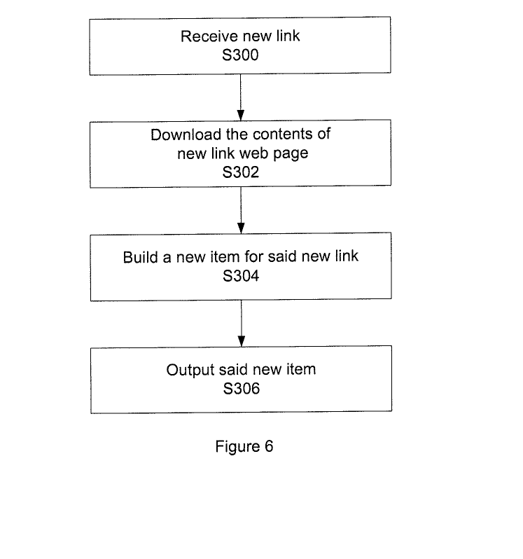

The target page crawler 26 is also connected to an article crawler 30 to which it passes new links. The article crawler 30 also comprises a crawler service which crawls the contents of the identified new links, generates new items (articles) in the feed from the content of the crawled links as described in more detail with reference to FIG. 6. The article crawler 30 is also connected to the template database 24 and in the absence of user specified preferences, may use the templates to generate new items. The new items may be stored in an article database 32 and may be published by a publishing component comprising a feed publisher server 34. This publishes items generated by the article crawler as an RSS feed, each RSS <item> containing the data generated by the process in FIG. 6. A separate RSS feed would be generated for each page-region specification being monitored the page-region monitor.

This system can be formed of many servers and databases distributed across a network, or in principle they can be consolidated at a single location or machine. In the arrangement of FIG. 3a, the region selection tool 20, target page crawler 22, article crawler 30 and feed publisher 34 are all provided on a single server. Alternatively, as shown in FIG. 3b, each component is provided by a separate server.

A plurality of users connected to the Internet via desktop computers 12 or mobile devices 10 can receive a feed from the feed publisher. The users receiving a feed (‘mobile users’) on mobile devices may alternatively be connected to a wireless network managed by a network operator, which is in turn connected to the Internet via a WAP gateway, IP router or other similar device (not shown explicitly). In the arrangement of FIG. 3b, the region selection tool 20 is downloaded and forms a component of the user device. It will be appreciated that other components of the system, e.g. the crawlers or publisher, may also form components of the user device. The other components of a user device such as a processor 52, memory 54, input/output 56 and user interface 58 are also shown in FIG. 3b. It will be appreciated that some or all of these components may also be provided on the other server(s) in the system.

FIG. 3b also shows an additional component, a crawler monitor 50, which is provided to monitor the outputs of the target page crawler or the article crawler to detect breakages. A breakage might occur if the target web pages were to change in format or structure, thus potentially invalidating the region specification (e.g. an XPath) for monitoring. This crawler monitoring component could be used to notify (e.g. by email or SMS) the maintainers of the target page crawler or the article crawler and/or the user.

FIG. 4 shows the steps carried out by the region selection tool. The tool may generate a graphical user interface that can be directed at a target web page. In step S100, the tool loads the target web page and displays its contents with the frame of the graphical user interface (e.g. as shown in FIG. 1). In step S102, the tool then provides for the graphical selection of one or more sub-regions of the page that should be used in the next component of the system. For example for step S102, with a mouse-driven interface, the user could be presented with a dynamic view of the web page that highlights candidate sub-regions (frames or panels) as a pointer is moved over the page (as shown in FIG. 2). When the desired sub-region is identified, a click of the mouse could signal the selection of that region as the region to monitor. Thus, as at step S104, the tool receives a selection of a sub-region.

Alternative to a mouse-driven interface for the tool could be a touch-driven interface for use e.g. on a tablet or mobile phone. In such an embodiment, the sub-regions of a given page could be selected with appropriate gestures. For example, dragging and pinching would achieve the typical pan and zoom functions, whilst tapping on an otherwise inactive area of the page could be used to select a region or frame of the page. In this example, the choice of zone to pick could be difficult to predict if there are several overlapping candidate zones. The interface could allow for this by cycling the selection through the set of candidates with each successive tap in the same area. For example, the first tap might select the smallest candidate region, which might be a html <p> tag. A second tap might then expand the selection to the smallest enclosing <div> tag. A third tap might then make a selection further “up” the document object model, with each successive tap changing the current selected zone for a larger candidate zone; eventually returning the selection to the first candidate. In such a way, a touch-driven interface could be used to select and refine the sub-regions to monitor. The advantage of using a touch-driven interface would be especially relevant to an embodiment where the resulting published feeds were consumable on a touch-driven portable device.

As set out in step S106, the tool optionally displays a textual representation of a selected sub-region. Candidate sub-regions would typically be HTML container elements such as <div> or <table> elements, but could also be the boundary of any graphically grouped collection of HTML objects. In the preferred embodiment, the tool also displays a textual representation of the current selection specification, for example as the XPath of the selected framing element. Such an XPath could then be modified directly by the user for more manual, less graphical, control of the region(s) to monitor. For example, as shown in FIG. 2, the selection is displayed as “/html/body/div/div([2]”.

The graphical user interface and associated tool could be of further assistance to the user if it also highlighted any contained links (e.g. <a> elements). This would help the user to see which links would be included and which would be excluded by the current region selection.

At step S108, the tool determines whether or not the selection of sub-regions is finished. If not, the user could then optionally make additional selections or modify the existing selection by either narrowing or widening its scope. Finally, once the selection is finalised and whether exposed to the user or not as in step S106, once the selections have been finalised, the tool outputs the sub-region specification. The output may be stored in a database or may be sent direct to the page-region monitor tool.

FIG. 5 shows the steps carried out by the target page crawler (or page region monitor tool). Initially, at step S200, the page-region monitor tool receives a sub-region specification for a target web page. The receiving step may be triggered by a user, e.g.

after a user has set up the specification on the region selection tool, or may be automated by the page-region monitor tool itself by accessing the specification database. At step S202, for each test of a candidate web page, the crawler downloads the contents (HTML) of the page. At step S204, the tool identifies the subset of that HTML corresponding to the sub-region specification(s) associated with that page. The crawler maintains a history, of at least the last crawl, of the contents of each sub-region in a history database. As at step S208, on each new crawl, the crawler service compares the current contents with the previous contents of a sub-region to determine if there are new links (e.g. <a> elements). Each new link (i.e. a link that is now present that was not present in the previous crawl) is output at step S210, e.g. to the article crawler.

FIG. 6 shows the steps carried out by the article crawler which is a crawler service that is deployed similarly to the crawler service described in FIG. 5. The first step S300 is the receipt of a new link to load as identified by the page-region monitor tool in FIG. 5. For each link to crawl, this crawler loads the target web page (identified by the link itself) at step S302. At step S304, the crawler uses the contents of that web page to build a new item (also termed article).

In the preferred embodiment, the new item contains a title, a thumbnail image and a summary paragraph of text. The title could be extracted from either the anchor text of the originating link or the <title> element of the page itself. The image could be the biggest image on the page (excluding the background image), or some other algorithm to determine the most representative image on the page. The summary paragraph could be the identified as the first contiguous run of text data longer than 10 words long, or some other algorithm to determine the best text summary of the contents of the page.

Alternative algorithms for deciding on the best (or most representative) image on a crawled page include algorithms that use one or more of the following: comparing source URLs to known ad-provider lists (ad-blocking), looking for images with reasonable aspect ratio (to e.g. exclude long/thin images more likely to be page decoration than representative of the page content), applying a minimum and/or maximum size or area of an image (to e.g. exclude iconography or background images), consideration of the entropy per pixel (e.g. to help select photographs over line-based iconography), ignoring common images (either common to current page, or common across several pages from the same site), ignoring images with common advert dimensions, ignoring images occurring too near the top of the web page (to e.g. exclude logo images).

Another embodiment, described below, provides further tooling for the user to define how to construct an item, or article, from the target page. Still other embodiments might choose to simply use the contents of the whole page as the article contents.

Finally, at step S306, the article crawler passes each new item that it has constructed to the publishing component of the system.

Optionally, the region selection tool can be extended to provide support for how an item is generated in the article crawler. For example, as shown in FIG. 7, once a sub-region to monitor by the page region monitor has been identified, e.g. in the last step of FIG. 5, the region selection tool could load the page of the first link found within the specified sub-region (step S400). The tool could then provide the user with the means to select which part of the page to use as the item title (step S402), which image to use as the image thumbnail (step S404), and which paragraph of text to use as the description (step S406). In further assistance to the user, the tool could then show examples (for example, as a ‘test’ mode) of what the other items in the specific region will look like (step S408). The user then has the chance to fine tune the definition of how to generate the items (e.g. by looping back through steps S402 to S408) before finally outputting the template for each item.

In all of the above embodiments, the feed may be received and/or the sub-region specification may be conducted on a mobile device which may be any kind of mobile computing device, including laptop and hand held computers, portable music players, portable multimedia players, mobile phones. Users can use mobile devices such as phone-like handsets communicating over a wireless network, or any kind of wirelessly-connected mobile devices including PDAs, notepads, point-of-sale terminals, laptops etc. Each device typically comprises one or more CPUs, memory, I/O devices such as keypad, keyboard, microphone, touchscreen, a display and a wireless network radio interface.

These devices can typically run web browsers or microbrowser applications e.g. Openwave™, Access™, Opera™, Mozilla™, browsers, which can access web pages across the Internet. These may be normal HTML web pages, or they may be pages formatted specifically for mobile devices using various subsets and variants of HTML, including cHTML, WML, DHTML, XHTML, XHTML Basic and XHTML Mobile Profile. The browsers allow the users to click on hyperlinks within web pages which contain URLs (uniform resource locators) which direct the browser to retrieve a new web page.

The Web server can be a PC type computer or other conventional type capable of running any HTTP (Hyper-Text-Transfer-Protocol) compatible server software as is widely available. The Web server has a connection to the Internet. These systems can be implemented on a wide variety of hardware and software platforms.

The servers for crawling or metacrawling can be implemented using standard hardware. The hardware components of any server typically include: a central processing unit (CPU), an Input/Output (I/O) Controller, a system power and clock source; display driver; RAM; ROM; and a hard disk drive. A network interface provides connection to a computer network such as Ethernet, TCP/IP or other popular protocol network interfaces. The functionality may be embodied in software residing in computer-readable media (such as the hard drive, RAM, or ROM). A typical software hierarchy for the system can include a BIOS (Basic Input Output System) which is a set of low level computer hardware instructions, usually stored in ROM, for communications between an operating system, device driver(s) and hardware. Device drivers are hardware specific code used to communicate between the operating system and hardware peripherals. Applications are software applications written typically in C/C++, Java, assembler or equivalent which implement the desired functionality, running on top of and thus dependent on the operating system for interaction with other software code and hardware. The operating system loads after BIOS initializes, and controls and runs the hardware. Examples of operating systems include Linux™, Solaris™, Unix™, OSX™ Windows XP™ and equivalents.

The region selection tool may provide for user login. The user is identified by registering a username and password and then subsequently by logging in with the same username and password. The registration process is a one-time process per user. In a preferred embodiment, the login process is also a one-time process per user by caching their credentials (or a unique key representing their identity) in a cookie. However, where cookies are not supported then the user is required to provide username and password per result publication. The user could be required to login at the first page of the graphical user interface, however, in the preferred embodiment, the user is only prompted for login (if not already identified) when first attempting to connect.

No doubt many other effective alternatives will occur to the skilled person. It will be understood that the invention is not limited to the described embodiments and encompasses modifications apparent to those skilled in the art lying within the spirit and scope of the claims appended hereto.

1. A system for monitoring changes to a target web page, said web page comprising a plurality of sub-regions, wherein the system is configured to
display said target web page to a user;
receive a user specification of at least one sub-region within said displayed target web page;
download, at a subsequent time, said target web page associated with said user specification;
identify said at least one sub-region of said user specification within said target web page;
determine whether or not there have been any changes to said at least one sub-region, and
if there are any changes, output an update comprising data from said at least one sub-region.

2. A system according to claim 1, wherein the system is further configured to display said target web page to a user within a graphical user interface such that said user creates said user specification using said graphical user interface.

3. A system according to claim 2, wherein the system is further configured to display said target web page together with a textual representation of said user selection of at least one sub-region within said graphical user interface.

4. A system according to claim 1, wherein the system is further configured to store said user specification in a specification database.

5. A system according to claim 1, wherein the system is further configured to determine whether or not a new link is included in said at least one sub-region and, if there is a new link, to output said new link.

6. A system according to claim 5, wherein the system is further configured to:
download a new web page associated with said new link;
generate an article derived from said new web page; and
output said article as said update.

7. A system according to claim 6, wherein said article comprises one or more of a title selected from said new web page, a thumbnail selected from an image on said new web page and a description selected from text on said new web page.

8. A system according to claim 6, wherein the system is further configured to
display said new web page to a user; and
receive a user defined template of an article to be based on said new web page.

9. A system according to claim 8, wherein the system is further configured to display said new web page to a user within a graphical user interface such that said user creates said user defined article template using said graphical user interface.

10. A system according to claim 8, wherein the system is further configured to store said user defined template in an article template database.

11. A system for providing information on changes to a target web page, said web page comprising a plurality of sub-regions, wherein the system is configured to
access a user sub-region specification specifying a target web page and at least one of said sub-regions within said target web page;
download said target web page associated with said user specification;
identify said at least one sub-region of said user specification within said target web page;
determine whether or not there is a new link within said at least one sub-region, and
if there is a new link, download a new web page associated with said new link;
generate an article derived from said new web page; and
output said article as an update.

12. A system according to claim 10, wherein the system is configured to access said user specification from a specification database which stores a plurality of said user specifications each associated with a particular target web page.

13. A system according to claim 12, wherein the system is configured to access said user specification at periodic intervals and iterate through said download, identify, determine, generate and output steps.

14. A system according to claim 11, wherein the system is configured to store said at least one sub-region in a history database after each said identifying step.

15. A system for providing update information on changes to a target web page, said web page comprising a plurality of sub-regions, wherein the system is configured to
display said target web page to a user;
receive a user specification of at least one sub-region within said displayed target web page;
download, at a subsequent time, said target web page associated with said user specification;
identify said at least one sub-region of said user specification within said target web page;
determine whether or not there is a new link within said at least one sub-region, and
if there is a new link, download a new web page associated with said new link;
generate an article derived from said new web page; and
output said article as an update.

16. A method of monitoring changes to a target web page, said web page comprising a plurality of sub-regions, the method comprising
displaying said target web page to a user;
receiving a user specification of at least one sub-region within said displayed target web page;
downloading, at a subsequent time, said target web page associated with said user specification;
identifying said at least one sub-region of said user specification within said target web page;
determining whether or not there have been any changes to said at least one sub-region, and
if there are any changes, outputting an update comprising data from said at least one sub-region.

17. A carrier carrying processor control code which when running on a computer causes the computer to carry out the method of claim 16.

18. A method for providing information on changes to a target web page, said web page comprising a plurality of sub-regions, the method comprising:
accessing a user sub-region specification specifying a target web page and at least one of said sub-regions within said target web page;
downloading said target web page associated with said user specification;
identifying said at least one sub-region of said user specification within said target web page;
determining whether or not there is a new link within said at least one sub-region, and
if there is a new link, downloading a new web page associated with said new link;
generating an article derived from said new web page; and
outputting said article as an update.

19. A carrier carrying processor control code which when running on a computer causes the computer to carry out the method of claim 18.
